(19) United States
(12) Patent Application Publication
(10) Pub. No.: US 2018/0258289 A1
(43) Pub. Date: Sep. 13, 2018

(54) ZINC-SULFIDE PIGMENTS COATED WITH SIO2-AGGLOMERATES

(71) Applicant: MERCK PATENT GMBH, DARMSTADT (DE)

(72) Inventors: Helge Bettina KNIESS, Rossdorf (DE); Ulrich QUITTMANN, Floersheim (DE); Oliver Robert PIENING, Gross-Zimmern (DE)

(73) Assignee: MERCK PATENT GMBH, DARMSTADT (DE)

(21) Appl. No.: 15/756,295

(22) PCT Filed: Jul. 29, 2016
(86) PCT No.: PCT/EP2016/001321

§ 371 Date: Feb. 28, 2018

(30) Foreign Application Priority Data
Aug. 28, 2015 (EP) 15182995.9

(51) Int. Cl. C09C 1/04; C09C 3/06; C08L 77/00; C08K 7/14; C08K 9/02

(52) U.S. Cl. CPC C09C 1/04; C09C 3/063; C08L 77/00; C08K 7/14; C08K 9/02; C08K 2003/3036; C01P 2004/61; C01P 2004/62; C01P 2004/64; C01P 2004/51; C01P 2006/62; C01P 2004/32

(57) ABSTRACT

The present invention relates to coated zinc sulfide pigments and to the use thereof, preferably in paints, automotive paints, industrial coatings, powder coatings, plastics, printing inks, ceramic glazes and cosmetic formulations, and to a process for the preparation thereof.

The present invention relates to coated zinc sulfide pigments and to the use thereof, preferably in paints, automotive paints, industrial coatings, powder coatings, plastics, printing inks, ceramic glazes and cosmetic formulations, and to a process for the preparation thereof.

The use of zinc sulfide, for example in image tubes, luminescent watch dials or electroluminescent films, is known. For these applications, the zinc sulfide is frequently doped with other ions, for example from the group Al, Cu, Ag, Mn, Au or Ga.

In indoor applications, zinc sulfide is, owing to the high refractive index of 2.37, frequently employed as white pigment, for example in grouts and sealants, primers, plastics. A disadvantage for use as white pigment outdoors is the limited resistance of zinc sulfide to UV light, chemicals and temperature. In the case of the self-decomposition of zinc sulfide caused by weathering influences, hydrogen sulfide, for example, forms.

Owing to the low Mohs hardness of 3, zinc sulfide has very low abrasiveness. It is therefore widely employed as white pigment in glass-fibre-reinforced plastics. A disadvantage for use as white pigment in glass-fibre-reinforced plastics here is also the limited resistance of zinc sulfide to UV light and oxygen.

Titanium dioxide, employed as alternative white pigment in glass-fibre-reinforced plastics, has high abrasiveness owing to its higher Mohs hardness of 5.5-6.5, which results in breaking of the glass fibres, as a result of which the pigmented plastic experiences a considerable loss in strength.

One possibility for the stabilisation of zinc sulfide pigments is, for example, the aftertreatment of the pigment surface. WO 2008/065208 A1 discloses, for example, the organic or inorganic aftertreatment of a nanoscale and substantially transparent zinc sulfide having reduced or absent white-pigment properties, for example with SiO₂, Al₂O₃, ZrO₂, TiO₂ and/or metal phosphates. This aftertreatment serves to prevent agglomeration of the particles in order to ensure optimum distribution in the application. This is only achieved if the layer thickness of the aftertreatment does not exceed a few nm (monomolecular). However, the aftertreatment described there does not result in UV stabilisation of the zinc sulfide.

DE 10 2013 105 794 A1 discloses the preparation of zinc sulfide particles having a cobalt-containing metal oxide coating for UV stabilisation. However, these pigments may result in slight discolouration of the plastic. Furthermore, the pigments are physiologically unacceptable owing to the cobalt content.

The patent specification AT 235438 furthermore discloses a process for the stabilisation of zinc sulfide by coating with SiO₂, in which the white pigment is suspended in an aqueous solution of an alkali metal salt of the isopoly-acids of silicon and this suspension is flocculated using a solution of a mixture of alkaline-earth metal chloride and/or aluminium chloride. The flocculation solution additionally contains a salt of the metals iron, cobalt, nickel, copper, cadmium, titanium, zirconium or cerium. However, this process is very complicated and expensive owing to the complex composition.

The object of the present invention is to stabilise zinc sulfide in such a way that it can be employed virtually universally in all conceivable indoor and outdoor applications. However, the hiding power of the zinc sulfide should not be impaired by the stabilisation.

Surprisingly, it has now been found that pure zinc sulfide pigments no longer have the above-mentioned disadvantages due to a coating with SiO₂ agglomerates on the surface and thus satisfy the desired requirement profile. The zinc sulfide pigments coated in this way exhibit significantly increased stability to UV light, chemicals and temperature. Furthermore, this surface coating only impairs the hiding power of the zinc sulfide pigment insignificantly or not at all. The stabilised zinc sulfide pigment is thus particularly suitable as white pigment for use in plastics, very particularly preferably for glass-fibre-reinforced plastics.

The present invention thus relates to zinc sulfide pigments which are distinguished by the fact that they are coated on the surface with SiO₂ agglomerates.

The present invention furthermore relates to a process for the preparation of the coated zinc sulfide pigments and to the use of the zinc sulfide pigments as white pigment and/or as additive, inter alia in paints, coatings, plastics, printing inks and in cosmetic formulations.

All zinc sulfides that are known to the person skilled in the art and/or are commercially available can be coated on the surface with the SiO₂ agglomerates. A starting material which can be used is, for example, commercially available zinc sulfide from Sachtleben or Tribotecc GmbH.

In addition to the improved stability to UV light, chemicals and temperature, the zinc sulfide coated with SiO₂ agglomerates is distinguished by a smoother particle surface, resulting in better incorporation and distribution in the application medium. A further advantage of the smoother surface is greater lightness with comparable hiding power, enabling higher gloss and improved luminance to be obtained in the application medium, and more flexible colouring of the media at the same time as improved colour purity. The lightness is determined in this patent application by measurement of the L* value in the CIELab colour space (measured on smoothed powder using a CR 410 Chroma Meter, Konica Minolta Sensing Europe B.V.). The L* value of the zinc sulfide powder coated with SiO₂ agglomerates is preferably 96-100, in particular 97-99, whereas the L* value of uncoated zinc sulfide (Sachtolith HDS, Sachtleben) has an L* value of 93.5-96.5, in particular 94-96.

Commercially available zinc sulfide frequently contains impurities, such as proportions of barium sulfate. However, these impurities do not influence the coating with SiO₂ agglomerates or the result of stabilisation of the zinc sulfide pigments according to the invention.

Furthermore, the commercially available zinc sulfide pigments have frequently already been organically aftertreated, i.e. a thin (generally <5 nm) organic layer of, for example, fatty acids, carboxylic acids, surfactants, metal soaps, alcohols, polyalcohols, polyethylene glycols, organic esters, phosphoric acid esters, organic phosphonic acids and phosphonates, silanes, siloxanes, organic titanates, organic zirconates, organic sulfonates, organic sulfates, is already present on the surface of the zinc sulfide pigments in order that the pigments can, for example, be suspended more easily in aqueous media. Organically aftertreated zinc sulfide is, for example, commercially available, for example Sachtolith HDS from Sachtleben Chemie GmbH.

For the zinc sulfide pigment according to the invention, the substrate employed can be both an organically or inorganically aftertreated zinc sulfide or an untreated zinc sulfide.

In a preferred embodiment, the zinc sulfide pigment is provided with an organic layer before the coating with SiO₂ agglomerates, since it can frequently be aftertreated more easily, in particular if the coating takes place in an aqueous medium.

The size of the zinc sulfide pigments is not crucial per se and can be matched to the respective intended application. In general, the zinc sulfide pigments have a particle size of 0.001-100 μm, preferably 0.005-50 μm, and in particular 0.01-1 μm.

The suitable starting material, organically or inorganically pretreated or untreated zinc sulfide pigment, preferably has the following particle size distributions:

D₁₀=0.001-50 μm, preferably 0.005-10 μm
D₅₀=0.005-80 μm, preferably 0.05-20 μm
D₉₀=0.1-100 μm, preferably 0.1-50 μm.

The characterisation of the particle size distribution is carried out by means of laser diffraction. In the present application, the particle size distribution is determined using the Malvern Mastersizer 2000 instrument.

The shape of the zinc sulfide pigments employed is likewise not crucial and can be oval, spherical, rod-shaped or flake-shaped. Spherical pigments are preferred.

Coating of the zinc sulfide pigments in this patent application means that the entire surface of the zinc sulfide pigment is covered with SiO₂ agglomerates.

The SiO₂ coating on the zinc sulfide pigments preferably has a layer thickness of 0.1 to 300 nm, in particular from 0.1 to 100 nm and very particularly preferably from 1 to 80 nm.

The SiO₂ content, based on the entire pigment, is preferably 2-99%, in particular 5-80% and particularly preferably 5-40%, depending on the particle size of the zinc sulfide used.

The coating of the zinc sulfide pigments with the SiO₂ agglomerates is easy to carry out. It can be carried out, for example, in a fluidised-bed reactor by gas-phase coating, in a spray dryer, by PVD, CVD, sol-gel methods or by wet-chemical coating (aqueous or solvent-based).

The zinc sulfide stabilised in accordance with the invention is preferably prepared by the wet-chemical process.

In the case of wet coating, the substrates (treated or untreated zinc sulfide pigments) are, for example, suspended in water and mixed with a water-glass solution at a hydrolysis-suitable pH which is selected so that the SiO₂ is precipitated directly onto the pigments without secondary precipitations occurring. The pH is usually kept constant by simultaneous metered addition of a base and/or acid. The treated pigments are subsequently separated off, washed and dried at 50-150° C., preferably 80-120° C., for 6-18 h and subsequently calcined for 0.25-2 h. In general, the calcination temperatures are in the range from 200-600° C., preferably 300-550° C. The calcined pigment can subsequently also be sieved. The precipitation of the SiO₂ onto the zinc sulfide pigment is generally carried out by addition of a potassium or sodium water-glass solution, preferably a sodium water-glass solution, at a suitable pH.

The significantly improved stability of the zinc sulfide coated with SiO₂ agglomerates compared with the products from the prior art with respect to UV light, temperature and/or chemicals opens up new potential applications, for example outdoors, where zinc sulfide pigments could hitherto not be employed owing to poor stability. Furthermore, for example, the production of infrared glasses and infrared ceramics, for example for thermal imaging cameras, distance meters, sensors, can be simplified, since here zinc sulfide pigments are employed as a key material owing to the high transparency in the IR region and are applied to glasses, for example, by means of a complex CVD process. Furthermore, the increased stability of the coated zinc sulfide pigment according to the invention is advantageous if the zinc sulfide is employed at temperatures>500° C., for example if it has to be modified further or if work has to be carried out at a pH of <2.5.

The concentration of the coated zinc sulfide pigment in the application system to be pigmented is generally in the range from 0.01-20% by weight, preferably 0.05-10 and in particular 0.1-2% by weight, based on the total solids content of the system. It is generally dependent on the specific application case.

The coated zinc sulfide pigments prepared in accordance with the invention can be employed in paints, for example automotive and industrial paints, solvent- and water-based, powder coatings, plastics, printing inks, grouts, sealants, ceramic glazes or cosmetic formulations. The use of the pigment according to the invention in synthetic organic polymers and moulded parts made therefrom is particularly preferred. Of the synthetic organic polymers, thermosets, elastomers and thermoplastics, in particular, are of importance. The pigment according to invention is suitable, in particular, for glass-fibre-reinforced polyamides.

The invention also relates to the use of the zinc sulfide pigments according to the invention in paints, coatings, powder coatings, printing inks, security printing inks, plastics, ceramic materials, enamels, glasses, paper, in toners for electrophotographic printing processes, in seed, in greenhouse sheeting and tarpaulins, as absorbers in the laser marking of paper and plastics, in cosmetic formulations, for the preparation of pigment pastes with water, organic and/or aqueous solvents, for the preparation of pigment preparations and dry preparations, such as, for example, granules.

The following examples are intended to explain the invention without restricting it. The percent data relate, unless indicated otherwise, to the weight.

### EXAMPLES

### Example 1: ZnS:SiO₂=89:11, 300° C.

100 g of ZnS (Sachtolith HDS, Sachtleben Chemie GmbH) having an average particle size of 210 nm (measured by the laser diffraction method using a measuring instrument from Malvern Ltd., UK, Malvern 2000) are heated to 75° C. with stirring in 2 l of demineralised water.

The pH of the suspension is now adjusted to 7.5 using 32% sodium hydroxide solution.

A sodium water-glass solution (45 g of sodium water-glass solution, comprising 27.6% of SiO₂, are dissolved in 47 g of fully deionised water) is then metered in, during which the pH is kept constant at 7.5 by simultaneous dropwise addition of 10% hydrochloric acid. When the addition is complete, the mixture is stirred for a further 0.5 h. The pH is subsequently adjusted to 5 using 10% hydrochloric acid, and the mixture is stirred for a further 15 min. The product is filtered, washed, dried, calcined at 300° C. and sieved through a 100 μm sieve.

### Example 2: ZnS:SiO₂=91:9, 450° C.

100 g of ZnS (Sachtolith HDS, Sachtleben Chemie GmbH) having an average particle size of 210 nm (measured by the laser diffraction method using a measuring instrument from Malvern Ltd., UK, Malvern 2000) are heated to 75° C. with stirring in 2 l of demineralised water.

The pH of the suspension is now adjusted to 9.0 using 32% sodium hydroxide solution. A sodium water-glass solution (36.2 g of sodium water-glass solution, comprising 27.6% of SiO₂, are dissolved in 36.2 g of fully deionised water) is then metered in, during which the pH is kept constant at 9.0 by simultaneous dropwise addition of 10% hydrochloric acid. When the addition is complete, the mixture is stirred for a further 0.5 h. The pH is subsequently adjusted to 4 using 10% hydrochloric acid, and the mixture is stirred for a further 15 min. The product is filtered, washed, dried, calcined at 450° C. and sieved through a 100 μm sieve.

### Example 3: ZnS:SiO₂=91:9, 500° C., acetic acid

100 g of ZnS (Sachtolith HDS, Sachtleben Chemie GmbH) having an average particle size of 210 nm (measured by the laser diffraction method using a measuring instrument from Malvern Ltd., UK, Malvern 2000) are heated to 75° C. with stirring in 2 l of demineralised water.

The pH of the suspension is now adjusted to 7.5 using 32% sodium hydroxide solution. A sodium water-glass solution (36.2 g of sodium water-glass solution, comprising 27.6% of SiO₂, are dissolved in 36.2 g of fully deionised water) is then metered in, during which the pH is kept constant at 7.5 by simultaneous dropwise addition of 3% acetic acid. When the addition is complete, the mixture is stirred for a further 0.5 h. The pH is subsequently adjusted to 4 using 3% acetic acid, and the mixture is stirred for a further 15 min. The product is filtered, washed, dried, calcined at 450° C. and sieved through a 100 μm sieve.

### Example 4: ZnS:SiO₂=83:17, 450° C.

100 g of ZnS (Sachtolith HDS, Sachtleben Chemie GmbH) having an average particle size of 210 nm (measured by the laser diffraction method using a measuring instrument from Malvern Ltd., UK, Malvern 2000) are heated to 75° C. with stirring in 2 l of demineralised water.

The pH of the suspension is now adjusted to 8.0 using 32% sodium hydroxide solution. A sodium water-glass solution (72.5 g of sodium water-glass solution, comprising 27.6% of SiO₂, are dissolved in 72.5 g of fully deionised water) is then metered in, during which the pH is kept constant at 8.0 by simultaneous dropwise addition of 10% hydrochloric acid. When the addition is complete, the mixture is stirred for a further 0.5 h. The pH is subsequently adjusted to 5 using 10% hydrochloric acid, and the mixture is stirred for a further 15 min. The product is filtered, washed, dried, calcined at 450° C. and sieved through a 100 μm sieve.

### Example 5: ZnS:SiO₂=67:33, 450° C.

100 g of ZnS (Sachtolith L, Sachtleben Chemie GmbH) having an average particle size of 220 nm (measured by the laser diffraction method using a measuring instrument from Malvern Ltd., UK, Malvern 2000) are heated to 75° C. with stirring in 2 l of demineralised water.

The pH of the suspension is now adjusted to 7.5 using 32% sodium hydroxide solution. A sodium water-glass solution (181.2 g of sodium water-glass solution, comprising 27.6% of SiO₂, are dissolved in 181.1 g of fully deionised water) is then metered in, during which the pH is kept constant at 7.5 by simultaneous dropwise addition of 10% hydrochloric acid. When the addition is complete, the mixture is stirred for a further 0.5 h. The pH is subsequently adjusted to 5 using 10% hydrochloric acid, and the mixture is stirred for a further 15 min. The product is filtered, washed, dried, calcined at 450° C. and sieved through a 100 μm sieve.

### Example 6: ZnS:SiO₂=89:11, 450° C.

100 g of ZnS (Sachtolith HDS, Sachtleben Chemie GmbH) having an average particle size of 210 nm (measured by the laser diffraction method using a measuring instrument from Malvern Ltd., UK, Malvern 2000) are heated to 75° C. with stirring in 2 l of demineralised water.

The pH of the suspension is now adjusted to 7.5 using 32% sodium hydroxide solution.

A sodium water-glass solution (45 g of sodium water-glass solution, comprising 27.6% of SiO₂, are dissolved in 47 g of fully deionised water) is then metered in, during which the pH is kept constant at 7.5 by simultaneous dropwise addition of 10% hydrochloric acid. When the addition is complete, the mixture is stirred for a further 0.5 h. The pH is subsequently adjusted to 5 using 10% hydrochloric acid, and the mixture is stirred for a further 15 min. The product is filtered, washed, dried, calcined at 450° C. and sieved through a 100 μm sieve.

The powder has an L* value (measured using a CR 410 Chroma Meter, Konica Minolta Sensing Europe B.V.) of 97.3.

### Example 7: ZnS:SiO₂=93:7, 450° C.

100 g of ZnS (Sachtolith HDS, Sachtleben Chemie GmbH) having an average particle size of 210 nm (measured by the laser diffraction method using a measuring instrument from Malvern Ltd., UK, Malvern 2000) are heated to 75° C. with stirring in 2 l of demineralised water.

The pH of the suspension is now adjusted to 7.5 using 32% sodium hydroxide solution. A sodium water-glass solution (43.5 g of sodium water-glass solution, comprising 27.6% of SiO₂, are dissolved in 43.5 g of fully deionised water) is then metered in, during which the pH is kept constant at 7.5 by simultaneous dropwise addition of 10% hydrochloric acid. When the addition is complete, the mixture is stirred for a further 0.5 h. The pH is subsequently adjusted to 4 using 10% hydrochloric acid, and the mixture is stirred for a further 15 min. The product is filtered, washed, dried, calcined at 450° C. and sieved through a 100 μm sieve.

The powder has an L* value (measured using a CR 410 Chroma Meter, Konica Minolta Sensing Europe B.V.) of 98.3.

### Example 8: ZnS:SiO₂=91:9, 450° C.

100 g of ZnS (Sachtolith HDS, Sachtleben Chemie GmbH) having an average particle size of 210 nm (measured by the laser diffraction method using a measuring instrument from Malvern Ltd., UK, Malvern 2000) are heated to 75° C. with stirring in 2 l of demineralised water.

The pH of the suspension is now adjusted to 7.5 using 32% sodium hydroxide solution. A sodium water-glass solution (36.2 g of sodium water-glass solution, comprising 27.6% of SiO₂, are dissolved in 36.2 g of fully deionised water) is then metered in, during which the pH is kept constant at 7.5 by simultaneous dropwise addition of 10% hydrochloric acid. When the addition is complete, the mixture is stirred for a further 0.5 h. The pH is subsequently adjusted to 4 using 10% hydrochloric acid, and the mixture is stirred for a further 15 min. The product is filtered, washed, dried, calcined at 450° C. and sieved through a 100 μm sieve.

The powder has an L* value (measured using a CR 410 Chroma Meter, Konica Minolta Sensing Europe B.V.) of 97.6.

### Stability Investigations

Due to the SiO₂ coating, the coated product has a temperature stability which is 100 K higher compared with uncoated zinc sulfide, i.e. 650-700° C. instead of 550-600° C., measured by the TGA method using the NETZSCH TG 209F1 220-10-211-K instrument. This enables the formation of toxic sulfur dioxide on exposure to high temperatures to be avoided.

Due to the coating with SiO₂ agglomerates, stabilisation of the zinc sulfide to chemicals, in particular acids, furthermore occurs. To this end, in each case a 10% aqueous suspension of the products according to the invention is prepared, the pH is adjusted using 10% hydrochloric acid with stirring, and the amount of hydrogen sulfide liberated is measured (Drager test tube, Article Number 8101461). Whereas measurable amounts of hydrogen sulfide are already formed at a pH of 2.5 in the case of uncoated ZnS, these are not measurable even at pH 1.8 in the case of ZnS coated with SiO₂ agglomerates:

| Product | pH | H₂S amount in ppm |
|---|---|---|
| ZnS (Sachtolith HDS) | 2.5 | 0.2 |
| | 2.0 | 1 |
| | 1.8 | 4 |
| Product from Example 4 | 2.5 | not measurable (<0.2 ppm) |
| | 2.0 | not measurable (<0.2 ppm) |
| | 1.8 | not measurable (<0.2 ppm) |

### Use Example

### Use Example: Incorporation of ZnS/SiO₂ into Glass-Fibre-Reinforced Poly-Amide

The pigment obtained from Example of 4 is incorporated into glass-fibre-reinforced polyamide (Akulon K224-LG6/E, DSM) in an amount of 0.4% by means of an extruder. This compound is then moulded in an injection-moulding machine to give test plates and subjected to a UV stability test.

Measurement conditions (in Akulon K224-LG6/E black; contains 30% of glass fibres):

| | |
|---|---|
| Accelerated test conditions: | Atlas Weather-Ometer Ci4000 |
| Test standard: | VW PV 3930 |
| Specifications of test conditions: | Weathering in Moist, Hot Climate |
| Light source: | Xenon arc |
| Filtering: | Borosilicate S inner and outer |
| Radiation intensity (regulated): | 0.50 W/m²/nm at 340 nm |
| Black standard temperature: | 65 +/− 2° C. |
| Chamber air temperature: | 40 +/− 3° C. |
| Dry/wet cycle: | 102′ dry/18′ water spray |
| Relative humidity: | 70 +/− 10% |
| Light/dart cycle: | Continuous illumination |

### Test Results:

| | Grey scale |
|---|---|
| Sample | assessment (750 h) |
| TiO₂ reference (Kronos2900, KRONOS) | 3 |
| ZnS reference (Sachtolith HDS, | 2 |
| Sachtleben Chemie GmbH) | |
| ZnS/SiO₂ (Example 2) | 3 |
| ZnS/SiO₂ (Example 4) | 3-4 |

TABLE 1

| | Exposure | | | | | Grey scale |
|---|---|---|---|---|---|---|
| | Time [h] | L* | a* | b* | Delta E* | level |
| TiO₂ | 0 | 16.2 | 0.2 | −1.7 | 0.0 | 5 |
| (reference) | 250 | 17.5 | 0.1 | −2.0 | 1.4 | 4-5 |
| | 500 | 18.0 | 0 | −1.6 | 1.9 | 4-5 |
| | 700 | 23.2 | −0.3 | −0.7 | 7.1 | 3 |
| ZnS | 0 | 16.7 | −0.1 | −0.6 | 0.0 | 5 |
| (reference) | 250 | 22.3 | 0.1 | 0.2 | 5.6 | 3-4 |
| | 500 | 23.8 | 0.1 | 0.7 | 7.3 | 3 |
| | 700 | 25.7 | 0.3 | 0.2 | 9.1 | 2 |
| ZnS/SiO₂ | 0 | 16.1 | 0 | −1.4 | 0.0 | 5 |
| (Example 2) | 250 | 17.9 | 0 | −0.4 | 2.1 | 4 |
| | 500 | 19.8 | 0.2 | 0.1 | 4.0 | 3-4 |
| | 700 | 22.3 | 0.1 | −0.2 | 6.3 | 3 |
| ZnS/SiO₂ | 0 | 14.9 | 0.2 | −1.4 | 0.0 | 5 |
| (Example 4) | 250 | 16.9 | 0.2 | −0.5 | 2.2 | 4 |
| | 500 | 17.6 | 0.1 | −0.1 | 3.0 | 4 |
| | 700 | 19.3 | −0.1 | −0.5 | 4.5 | 3-4 |

Table 1 shows that the novel zinc sulfides according to Examples 2 and 4 which are coated with SiO₂ agglomerates exhibit significantly higher UV stability compared with the reference pigment ZnS (after exposure for 750 h) and have comparable UV stability compared with the reference pigment TiO₂ (after exposure for 750 h).

Notes on the average particle sizes (all measured at Merck by the laser diffraction method using a measuring instrument from Malvern Ltd., UK, Malvern 2000):

ZnS: Sachtolith HDS (Sachtleben) D₅₀=210 nm; D₉₅=0.62 μm
TiO₂: Kronos 2900 (Kronos) D₅₀=180 nm; D₉₅=0.84 μm

1. Coated zinc sulfide pigment, characterised in that it is coated on the surface with SiO₂ agglomerates.

2. Coated zinc sulfide pigment according to claim 1, characterised in that the zinc sulfide has particle sizes of 0.001-100 μm.

3. Coated zinc sulfide pigment according to claim 1, characterised in that the substrate used is an inorganically or organically pretreated zinc sulfide pigment.

4. Coated zinc sulfide pigment according to claim 1, characterised in that the zinc sulfide pigment is oval, spherical, rod-shaped or flake-shaped.

5. Coated zinc sulfide pigment according to claim 1, characterised in that the zinc sulfide pigment is spherical.

6. Coated zinc sulfide pigment according to claim 1, characterised in that the SiO₂ coating on the zinc sulfide pigment has a layer thickness of 0.1 to 300 nm.

7. Coated zinc sulfide pigment according to claim 1, characterised in that the SiO₂ content, based on the coated pigment, is 2 to 100%.

8. Process for the preparation of the coated zinc sulfide pigment according to claim 1, characterised in that the coating of the zinc sulfide pigment with SiO₂ agglomerates is carried out in a fluidised-bed reactor, by gas-phase coating, by PVD, CVD or by wet-chemical coating.

9. Process according to claim 8, characterised in that, in the case of wet-chemical coating, the zinc sulfide pigment is suspended in water and mixed with a water-glass solution at a hydrolysis-suitable pH which is selected so that the SiO₂ is precipitated out directly onto the pigment, the pH is kept constant by simultaneous metered addition of a base and/or acid, and the zinc sulfide pigment coated in this way is separated off, washed, dried and subsequently calcined at 200-600° C. and finally sieved.

10. A product selected from paints, coatings, powder coatings, printing inks, security printing inks, plastics, mouldings, ceramic materials, glasses, enamels, cosmetic formulations, pigment pastes with water, organic and/or aqueous solvents, pigment preparations and dry preparations, comprising a coated zinc sulfide pigment according to claim 1.

11. A glass-fibre-reinforced polyamides, comprising a coated zinc sulfide pigment according to claim 1.

12. Formulations comprising the coated zinc sulfide pigment according to claim 1.

13. Polymer matrix comprising the coated zinc sulfide pigment according claim 1.
